(19) United States
(12) Patent Application Publication
(10) Pub. No.: US 2026/0017450 A1
(43) Pub. Date: Jan. 15, 2026

(54) SYSTEM AND METHOD FOR AUTOMATIC TABLE IDENTIFICATION AND EXTRACTION IN DOCUMENTS

(71) Applicant: JPMorgan Chase Bank, N.A., New York, NY (US)

(72) Inventors: William WATSON, Long Beach, NY (US); Naan CHO, New York, NY (US)

(73) Assignee: JPMorgan Chase Bank, N.A., New York, NY (US)

(21) Appl. No.: 18/767,115

(22) Filed: Jul. 9, 2024

(51) Int. Cl. G06F 40/177; G06V 30/412; G06V 30/414

(52) U.S. Cl. CPC G06F 40/177; G06V 30/412; G06V 30/414

(57) ABSTRACT

Various methods and processes, apparatuses or systems, and media for automatic table identification and extraction in a document by utilizing one or more processors along with allocated memory are disclosed. The processor receives a variably sized document and streams content of the variably sized document line by line in a sliding window to identify breakpoints. The streaming is independent to the number of tables in the document, or length of the document, and the breakpoints identify start and end of a table. The processor also identifies and extracts a table within the document based on the breakpoints; implements spatially aware parsing algorithm for layout analysis, table constructions, and radial context search from the identified table; and automatically structures the table in structured triplets of index, column, and value that dictates a row, a column, and an entry value, respectively.

### TECHNICAL FIELD

This disclosure generally relates to data processing, and, more particularly, to methods and apparatuses for implementing a platform, language, cloud, and database agnostic automatic table identification and extraction module configured to implement an algorithm and methodology to structure tables in structured triplets of index, column, value that dictate the row (index), column (column), and entry value (value).

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Typically, tables in a document, i.e., a financial document, may be comprised on highly technical content in a spatially-aligned grid system. Specifically, financial documents may be exceptionally long. Thus, to have the full context of any value, that value may need to be considered with its column and row identifier, effectively forming a triplet of values (row-col-value). For example, in a financial statement, the column could be the fiscal year, the row be the expense item or fee, and the value may be the currency spent on that expense item in the column year. However, identifying these structures and retaining high fidelity alignments for extraction may prove to be very difficult. Conventional approaches/tools lack capabilities to efficiently stream content to identify breakpoints in the document to apply more sophisticated algorithms such as table identification, segmentation, and parsing.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic automatic table identification and extraction module configured to implement an algorithm and methodology to automatically identify and extract tables in documents (i.e., financial forms) and structure tables in structured triplets of index, column, value that dictate the row (index), column (column), and entry value (value), but the disclosure is not limited thereto.

Understanding the structure, alignment, and spatial configuration of tabular structures may be important in allowing for downstream question answering and inference tasks. In some embodiments, the automatic table identification and extraction module as disclosed herein may be configured to efficiently stream content to identify breakpoints in a document to apply more sophisticated algorithms such as table identification, segmentation, and parsing.

In some embodiments, the automatic table identification and extraction module may implement an algorithm and methodology to achieve the following: high-speed processing of Portable Document Format (PDF) documents (i.e., about hundreds of millions of pages in a very short period of time); implementing intelligent streaming algorithms that are capable of identifying superfluous content and reducing computational complexity to a logarithmic search space; implementing bounded recursive search algorithms to quickly organize data structures without additional overhead; implementing low-level, lightweight, and highly optimized parsing algorithms for real-time processing and rendering speeds; implementing extendable parallel processing framework with cloud computing resources for faster extraction, etc., but the disclosure is not limited thereto.

In some embodiments, a method for automatic table identification and extraction in a document by utilizing one or more processors along with allocated memory is disclosed. The method may include: receiving a variably sized document; streaming content of the variably sized document line by line in a sliding window to identify breakpoints, wherein the streaming is independent to the number of tables in the document, or length of the document, and wherein the breakpoints identify start and end of a table; identifying and extracting a table within the document based on the breakpoints; implementing spatially aware parsing algorithm for layout analysis, table constructions, and radial context search from the identified table; and automatically structuring the table in structured triplets of index, column, and value that dictates a row, a column, and an entry value, respectively.

In some embodiments, the variably sized document may include one or more of the following: Portable Document Formats (PDFs), Word, Hyper Text Markup Language (HTML), and Extensible Markup Language (XML), but the disclosure is not limited thereto.

In some embodiments, the method may further include: implementing an extract or partial fuzzy matching algorithm to find predefined keywords within the document to be utilized as the breakpoints.

In some embodiments, the method may further include: generating spatial coordinates by implementing spatial patterns as in repeating X, Y coordinates with whitespace between content from the identified table thereby diverging from normal free text that has a more random, uniform distribution of spatial alignments; and generating a data structure from the spatial coordinates, wherein the data structure stores non overlapping or disjoint subset of elements.

In some embodiments, the method may further include: aligning columns of the identified table based on spatial overlap of the X coordinates.

In some embodiments, the method may further include: plotting a histogram of space, on a row basis, to a next text content; and identifying an optimal threshold to differentiate normal text space from column separated spaces.

In some embodiments, the method may further include: linking row fields to values via Y coordinate overlap.

In some embodiments, in the radial context search, the method may further include: searching all points within a vector space that reside within a specified maximum distance or minimum score threshold from a query point.

In some embodiments, a system for automatic table identification and extraction in a document is disclosed. The system may include: a processor; and a memory operatively connected to the processor via a communication interface, the memory storing computer readable instructions, when executed, may cause the processor to: receive a variably sized document; stream content of the variably sized document line by line in a sliding window to identify breakpoints, wherein the streaming is independent to the number of tables in the document, or length of the document, and wherein the breakpoints identify start and end of a table; identify and extract a table within the document based on the breakpoints; implement spatially aware parsing algorithm for layout analysis, table constructions, and radial context search from the identified table; and automatically structure the table in structured triplets of index, column, and value that dictates a row, a column, and an entry value, respectively.

In some embodiments, the processor may be further configured to: implement an extract or partial fuzzy matching algorithm to find predefined keywords within the document to be utilized as the breakpoints.

In some embodiments, the processor may be further configured to: generate spatial coordinates by implementing spatial patterns as in repeating X, Y coordinates with whitespace between content from the identified table thereby diverging from normal free text that has a more random, uniform distribution of spatial alignments; and generate a data structure from the spatial coordinates, wherein the data structure stores non overlapping or disjoint subset of elements.

In some embodiments, the processor may be further configured to: align columns of the identified table based on spatial overlap of the X coordinates.

In some embodiments, the processor may be further configured to: plot a histogram of space, on a row basis, to a next text content; and identify an optimal threshold to differentiate normal text space from column separated spaces.

In some embodiments, the processor may be further configured to: link row fields to values via Y coordinate overlap.

In some embodiments, in the radial context search, the processor may be further configured to: search all points within a vector space that reside within a specified maximum distance or minimum score threshold from a query point.

In some embodiments, a non-transitory computer readable medium configured to store instructions for automatic table identification and extraction in a document is disclosed. The instructions, when executed, may cause a processor to perform the following: receiving a variably sized document; streaming content of the variably sized document line by line in a sliding window to identify breakpoints, wherein the streaming is independent to the number of tables in the document, or length of the document, and wherein the breakpoints identify start and end of a table; identifying and extracting a table within the document based on the breakpoints; implementing spatially aware parsing algorithm for layout analysis, table constructions, and radial context search from the identified table; and automatically structuring the table in structured triplets of index, column, and value that dictates a row, a column, and an entry value, respectively.

In some embodiments, the instructions, when executed, may cause the processor to further perform the following: implementing an extract or partial fuzzy matching algorithm to find predefined keywords within the document to be utilized as the breakpoints.

In some embodiments, the instructions, when executed, may cause the processor to further perform the following: generating spatial coordinates by implementing spatial patterns as in repeating X, Y coordinates with whitespace between content from the identified table thereby diverging from normal free text that has a more random, uniform distribution of spatial alignments; and generating a data structure from the spatial coordinates, wherein the data structure stores non overlapping or disjoint subset of elements.

In some embodiments, the instructions, when executed, may cause the processor to further perform the following: aligning columns of the identified table based on spatial overlap of the X coordinates.

In some embodiments, the instructions, when executed, may cause the processor to further perform the following: plotting a histogram of space, on a row basis, to a next text content; and identifying an optimal threshold to differentiate normal text space from column separated spaces.

In some embodiments, the instructions, when executed, may cause the processor to further perform the following: linking row fields to values via Y coordinate overlap.

In some embodiments, in the radial context search, the instructions, when executed, may cause the processor to further perform the following: searching all points within a vector space that reside within a specified maximum distance or minimum score threshold from a query point.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automatic table identification and extraction module configured to implement an algorithm and methodology to automatically identify and extract tables in documents and structure tables in structured triplets of index, column, value in accordance with an embodiment.

FIG. 2 illustrates a diagram of a network environment with a platform, language, database, and cloud agnostic automatic table identification and extraction device in accordance with an embodiment.

FIG. 3 illustrates a system diagram for implementing a platform, language, database, and cloud agnostic automatic table identification and extraction device having a platform, language, database, and cloud agnostic automatic table identification and extraction module in accordance with an embodiment.

FIG. 4 illustrates a system diagram for implementing a platform, language, database, and cloud agnostic automatic table identification and extraction module of FIG. 3 in accordance with an embodiment.

FIG. 5 illustrates a process implemented by the automatic table identification and extraction module of FIG. 4 to efficiently stream content line by line in a sliding window to identify relevant sections to further process in accordance with an embodiment.

FIG. 6 illustrates an HTML document streaming as implemented by the automatic table identification and extraction module of FIG. 4 in accordance with an embodiment.

FIG. 7 illustrates a flow chart of a process implemented by the platform, language, database, and cloud agnostic automatic table identification and extraction module of FIG. 4 for implementing an algorithm and methodology to automatically identify and extract tables in documents and structure tables in structured triplets of index, column, value in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

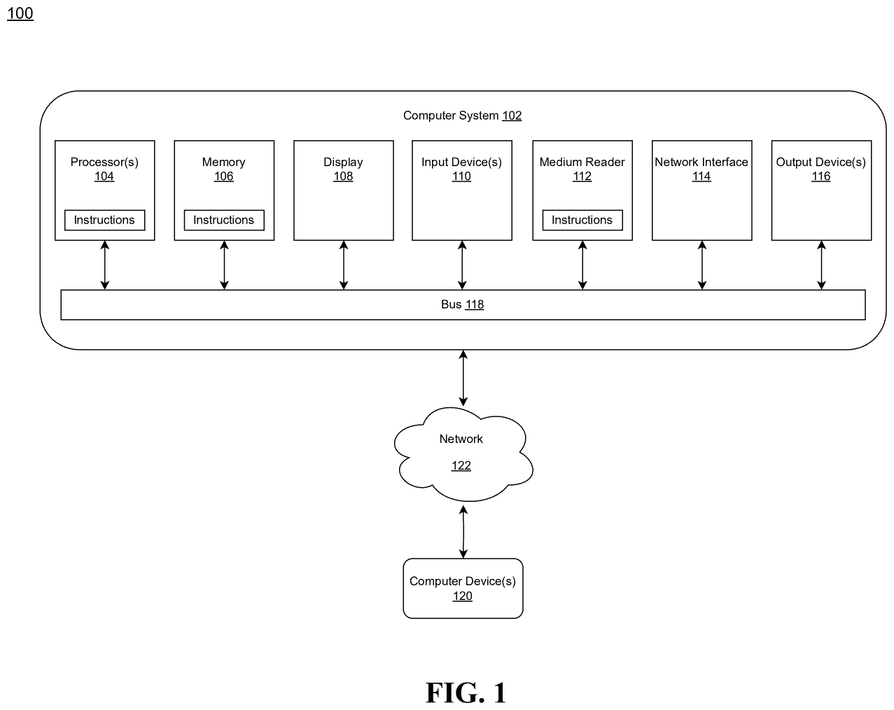

FIG. 1 is a system 100 for use in implementing a platform, language, database, and cloud agnostic automatic table identification and extraction module configured to implement an algorithm and methodology to automatically identify and extract tables in documents and structure tables in structured triplets of index, column, value in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automatic table identification and extraction module implemented by the system 100 may be platform, language, database, and cloud agnostic that may allow for consistent easy orchestration and passing of data through various components to output a desired result regardless of platform, browser, language, database, and cloud environment by writing programs accordingly. Since the disclosed process, in some embodiments, is platform, language, database, browser, and cloud agnostic, the automatic table identification and extraction module may be independently tuned or modified for optimal performance without affecting the configuration or data files. The configuration or data files, in some embodiments, may be written using JSON, but the disclosure is not limited thereto. For example, the configuration or data files may easily be extended to other readable file formats such as HTML, XML, YAML, etc., or any other configuration based languages.

In accordance with various embodiments of the present disclosure, the methods described herein may be implemented using a hardware computer system that executes software programs. Further, in a non-limited embodiment, embodiments may include distributed processing, component/object distributed processing, and an operation mode having parallel processing capabilities. Virtual computer system processing may be constructed to implement one or more of the methods or functionality as described herein, and a processor described herein may be used to support a virtual processing environment.

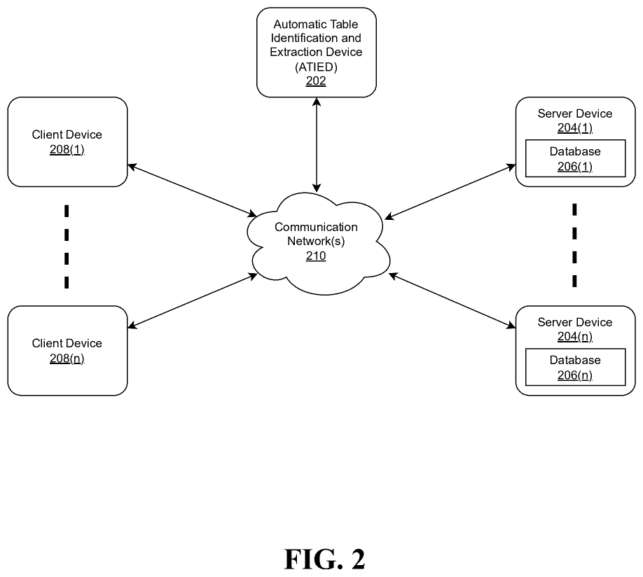

Referring to FIG. 2, a schematic of a network environment 200 for implementing a language, platform, database, and cloud agnostic automatic table identification and extraction device (ATIED) of the instant disclosure is illustrated.

In some embodiments, the above-described problems associated with conventional tools may be overcome by implementing a ATIED 202 as illustrated in FIG. 2 that may be configured for implementing a platform, language, database, and cloud agnostic automatic table identification and extraction module configured to implement an algorithm and methodology to automatically identify and extract tables in documents and structure tables in structured triplets of index, column, value, but the disclosure is not limited thereto.

The ATIED 202 may include one or more computer system 102s, as described with respect to FIG. 1, which in aggregate provide the necessary functions.

The ATIED 202 may store one or more applications that may include executable instructions that, when executed by the ATIED 202, cause the ATIED 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ATIED 202 itself, may be located in virtual server(s) running in a cloud-based computing environment rather than being tied to one or more specific physical network computing devices. Also, the application(s) may be running in one or more virtual machines (VMs) executing on the ATIED 202. Additionally, in one or more embodiments of this technology, virtual machine(s) running on the ATIED 202 may be managed or supervised by a hypervisor.

In the network environment 200 of FIG. 2, the ATIED 202 may be coupled to a plurality of server devices 204(1)-204(n) that hosts a plurality of databases 206(1)-206(n), and also to a plurality of client devices 208(1)-208(n) via communication network(s) 210. A communication interface of the ATIED 202, such as the network interface 114 of the computer system 102 of FIG. 1, operatively couples and communicates between the ATIED 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATIED 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ATIED 202 may be a standalone device or integrated with one or more other devices or apparatuses, such as one or more of the server devices 204(1)-204(n), for example. In one particular example, the ATIED 202 may be hosted by one of the server devices 204(1)-204(n), and other arrangements are also possible. Moreover, one or more of the devices of the ATIED 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ATIED 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ATIED 202 that may efficiently provide a platform for implementing a platform, language, database, and cloud agnostic automatic table identification and extraction module configured to implement an algorithm and methodology to automatically identify and extract tables in documents and structure tables in structured triplets of index, column, value, but the disclosure is not limited thereto.

The client devices 208(1)-208(n) may run interface applications, such as standard web browsers or standalone client applications, which may provide an interface to communicate with the ATIED 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the ATIED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ATIED 202, the server devices 204(1)-204(n), or the client devices 208(1)-208(n), for example, may be configured to operate as virtual instances on the same physical machine. For example, one or more of the ATIED 202, the server devices 204(1)-204(n), or the client devices 208(1)-208(n) may operate on the same physical device rather than as separate devices communicating through communication network(s) 210. Additionally, there may be more or fewer ATIEDs 202, server devices 204(1)-204(n), or client devices 208(1)-208(n) than illustrated in FIG. 2. In some embodiments, the ATIED 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

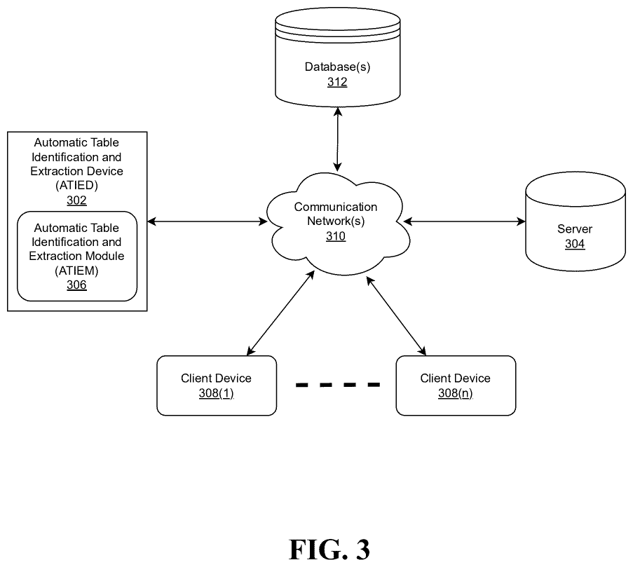

FIG. 3 illustrates a system diagram for implementing a platform, language, and cloud agnostic ATIED having a platform, language, database, and cloud agnostic automatic table identification and extraction module (ATIEM) in accordance with an embodiment.

As illustrated in FIG. 3, the system 300 may include an ATIED 302 within which an ATIEM 306 is embedded, a server 304, a database(s) 312, a plurality of client devices 308(1) . . . 308(n), and a communication network 310.

In some embodiments, the ATIED 302 including the ATIEM 306 may be connected to the server 304, and the database(s) 312 via the communication network 310. The ATIED 302 may also be connected to the plurality of client devices 308(1) . . . 308(n) via the communication network 310, but the disclosure is not limited thereto. The database(s) 312 may include one or more rule databases.

In an embodiment, the ATIED 302 is described and shown in FIG. 3 as including the ATIEM 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the ATIEM 306 may be configured to receive real-time feed of data from the plurality of client devices 308(1) . . . 308(n) and secondary sources via the communication network 310.

The ATIEM 306 may be configured to: receive a variably sized document; stream content of the variably sized document line by line in a sliding window to identify breakpoints, wherein the streaming is independent to the number of tables in the document, or length of the document, and wherein the breakpoints identify start and end of a table; identify and extract a table within the document based on the breakpoints; implement spatially aware parsing algorithm for layout analysis, table constructions, and radial context search from the identified table; and automatically structure the table in structured triplets of index, column, and value that dictates a row, a column, and an entry value, respectively, but the disclosure is not limited thereto.

The plurality of client devices 308(1) . . . 308(n) are illustrated as being in communication with the ATIED 302. In this regard, the plurality of client devices 308(1) . . . 308(n) may be “clients” (e.g., customers) of the ATIED 302 and are described herein as such. Nevertheless, it is to be known and understood that the plurality of client devices 308(1) . . . 308(n) need not necessarily be “clients” of the ATIED 302, or any entity described in association therewith herein. Any additional or alternative relationship may exist between either or both of the plurality of client devices 308(1) . . . 308(n) and the ATIED 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the ATIED 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ATIED 302 may be the same or similar to the ATIED 202 as described with respect to FIG. 2, including any features or combination of features described with respect thereto.

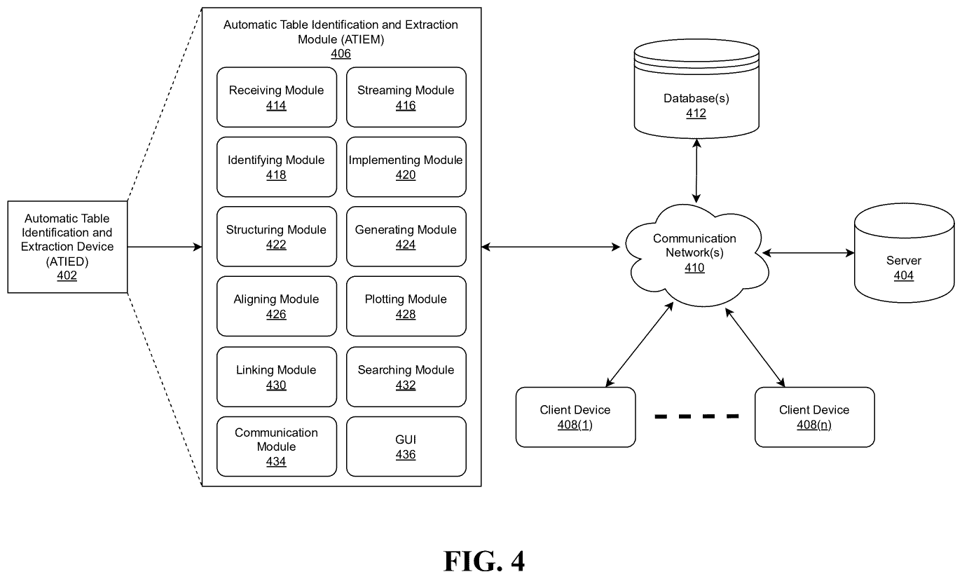

FIG. 4 illustrates a system diagram for implementing a platform, language, database, and cloud agnostic ATIEM of FIG. 3 in accordance with an embodiment.

In some embodiments, the system 400 may include a platform, language, database, and cloud agnostic ATIED 402 within which a platform, language, database, and cloud agnostic ATIEM 406 is embedded, a server 404, database(s) 412, and a communication network 410. In some embodiments, server 404 may comprise a plurality of servers located centrally or located in different locations, but the disclosure is not limited thereto.

In some embodiments, the ATIED 402 including the ATIEM 406 may be connected to the server 404 and the database(s) 412 via the communication network 410. The ATIED 402 may also be connected to the plurality of client devices 408(1)-408(n) via the communication network 410, but the disclosure is not limited thereto. The ATIEM 406, the server 404, the plurality of client devices 408(1)-408(n), the database(s) 412, the communication network 410 as illustrated in FIG. 4 may be the same or similar to the ATIEM 306, the server 304, the plurality of client devices 308(1)-308(n), the database(s) 312, the communication network 310, respectively, as illustrated in FIG. 3.

Details of the ATIEM 406 is provided below with corresponding modules that may be configured to, in combination, implement an algorithm and methodology to automatically identify and extract tables in documents (i.e., financial forms) and structure tables in structured triplets of index, column, value that dictate the row (index), column (column), and entry value (value), but the disclosure is not limited thereto.

Understanding the structure, alignment, and spatial configuration of tabular structures may be important in allowing for downstream question answering and inference tasks. In some embodiments, the ATIEM 406 as disclosed herein may be configured to efficiently stream content to identify breakpoints in a document to apply more sophisticated algorithms such as table identification, segmentation, and parsing.

In some embodiments, the ATIEM 406 may implement an algorithm and methodology to achieve the following: high-speed processing of PDF documents (i.e., about hundreds of millions of pages in a very short period of time); implementing intelligent streaming algorithms that are capable of identifying superfluous content and reducing computational complexity to a logarithmic search space; implementing bounded recursive search algorithms to quickly organize data structures without additional overhead; implementing low-level, lightweight, and highly optimized parsing algorithms for real-time processing and rendering speeds; implementing extendable parallel processing framework with cloud computing resources for faster extraction, etc., but the disclosure is not limited thereto.

In some embodiments, as illustrated in FIG. 4, the ATIEM 406 may include a receiving module 414, a streaming module 416, an identifying module 418, an implementing module 420, a structuring module 422, a generating module 424, an aligning module 426, a plotting module 428, a linking module 430, a searching module 432, a communication module 434, and GUI 436. In some embodiments, interactions and data exchange among these modules included in the ATIEM 406 provide the advantageous effects of the disclosed invention. Functionalities of each module of FIG. 4 may be described in detail below with reference to FIGS. 4-8.

In some embodiments, each of the receiving module 414, streaming module 416, identifying module 418, implementing module 420, structuring module 422, generating module 424, aligning module 426, plotting module 428, linking module 430, searching module 432, and the communication module 434 of the ATIEM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, streaming module 416, identifying module 418, implementing module 420, structuring module 422, generating module 424, aligning module 426, plotting module 428, linking module 430, searching module 432, and the communication module 434 of the ATIEM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, streaming module 416, identifying module 418, implementing module 420, structuring module 422, generating module 424, aligning module 426, plotting module 428, linking module 430, searching module 432, and the communication module 434 of the ATIEM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the ATIEM 406 of FIG. 4 may also be implemented by cloud based deployment.

In some embodiments, each of the receiving module 414, streaming module 416, identifying module 418, implementing module 420, structuring module 422, generating module 424, aligning module 426, plotting module 428, linking module 430, searching module 432, and the communication module 434 of the ATIEM 406 of FIG. 4 may be called via corresponding API, but the disclosure is not limited thereto.

In some embodiments, the process implemented by the ATIEM 406 may be executed via the communication module 434 and the communication network 410, which may comprise plural networks as described above. For example, in an embodiment, the various components of the ATIEM 406 may communicate with the server 404, and the database(s) 412 via the communication module 434 and the communication network 410 and the results may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

Financial documents, for example, may be exceptionally long. The ATIEM 406 may be configured to efficiently stream content to identify breakpoints in the document to apply more sophisticated algorithms such as table identification, segmentation, and parsing. Streaming algorithms implemented by the ATIEM 406 may be algorithms for processing data streams in which the input is presented as a sequence of items and may be examined in only a few passes, typically just one, but the disclosure is not limited thereto.

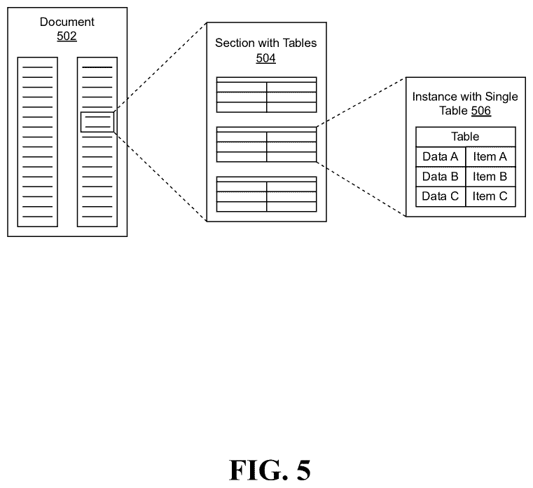

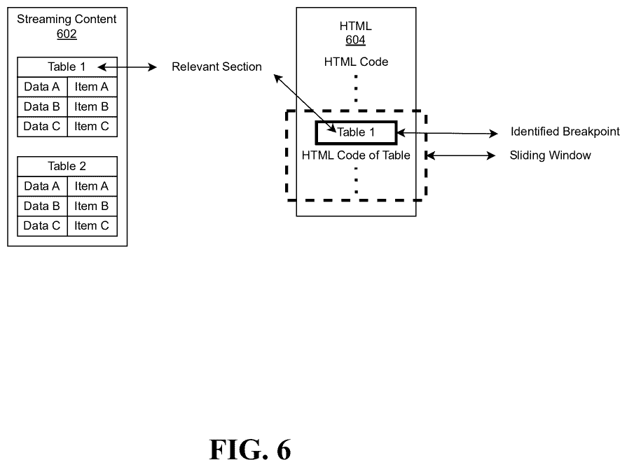

In some embodiments, the ATIEM 406 may be configured to execute high-speed processing of PDF documents by implementing low-memory streaming algorithms that may read partial documents, identifying segments that require further processing. The ATIEM 406 may implement a sliding window model in streaming (see, e.g., FIGS. 5 and 6 below). In this sliding window model, the function of interest is computing over a fixed-size window in the stream. As the stream progresses, items from the end of the window are removed from consideration while new items from the stream take their place.

In some embodiments, the ATIEM 406 may implement intelligent streaming algorithms that are capable of identifying superfluous content and reducing computational complexity to a logarithmic search space. For example, signals such as predefined keywords (found with extract or partial fuzzy matching) may be used as breakpoints. The ATIEM 406 may be configured to implement these algorithms for generating page identifiers, table tags in HTML, highly non-uniform spatial patterns in PDF (wide, circular patterns of white space between text content, indicative of a table row repeated across the lines of a document).

In some embodiments, bounded recursive search algorithm may be implemented by the ATIEM 406 to quickly organize data structures without additional overhead. For example, metadata may be utilized by the ATIEM 406 to track with fund or chapter the pointer is currently in. For instance, in financial documents, funds are split into separate chapters, and a table might be tied implicitly to a certain section/chapter/fund. Tracking these changes allows for digging deeper and maintain any hierarchical data related to the extract values.

In some embodiments, low-level, lightweight, and highly optimized parsing algorithms may be implemented by the ATIEM 406 for real-time processing and rendering speeds. For example, low-memory streaming may be implemented by the ATIEM 406 for plain text ingestions (only characters, no images or rendering required, simulated html and PDF spatial alignments from embedded text artifacts). The ATIEM 406 may also chunk documents (i.e., document 502 as illustrated in FIG. 5) for parallel processing. Each document may be independent, allowing for parallel or distributed computing for faster processing and scale.

In some embodiments, the ATIEM 406 may implement extendable parallel processing framework with cloud computing resources as mentioned above for even faster extraction.

FIG. 5 illustrates a process 500 implemented by the ATIEM 406 of FIG. 4 to efficiently stream content line by line in a sliding window to identify relevant sections to further process in accordance with an embodiment. As illustrated in FIG. 5, element 502 represents a document 502 as input. Inputs may be variably-sized documents, including HTML, XML, Word, PDF, etc., but the disclosure is not limited thereto. If inputs are Word documents, known conversion algorithms may be implemented by the ATIEM 406 to convert them into PDFs. In some embodiments optical character recognition algorithms may be implemented by the ATIEM 406 to extract contents from PDFs. As illustrated in FIG. 5, element 504 represents section with tables and element 506 represents an instance with a single table. The table may include corresponding data (data A, data B, data C, etc.) and item (i.e., item A, item B, item C, etc.), but the disclosure is not limited thereto. As illustrated in FIG. 5, documents 502 may be long streams of text. The ATIEM 406 may be configured to efficiently stream content line by line in a sliding window (see, e.g., FIG. 6) to identify relevant sections to further process. This process 500 may isolate tables from each other allowing for parallel computation of more expensive extractions.

FIG. 6 illustrates an HTML document streaming process 600 as implemented by the ATIEM 406 of FIG. 4 in accordance with an embodiment. In this example of an HTML document streaming process 600, the ATIEM 406 may be configured to identify a relevant section from the HTML 604, such as the “Statement of Assets and Liabilities” that has a HTML table (i.e., Table 1). The ATIEM 406 may insert a break point and capture the sliding window for further processing. The ATIEM 406 may close the break point and isolate the pages with tables. Metadata may be tracked on chapter sections, either from the table of contents, or third party document header detailing fund names.

For example, in some embodiments, in table identification, the ATIEM 406 may be configured to understand documents in different formats and lengths (e.g., thousands of pages per document). Lightweight streaming implemented by the ATIEM 406 may allow for constant memory overhead, and wherein intelligent chunking may be independent to the number of tables in a document, or length of document.

In some embodiments, the ATIEM 406 may be configured to implement a spatially aware parsing algorithm for layout analysis, table construction, and radial context search.

For example, a table (i.e., instance with singe table 506 as illustrated in FIG. 5 or Table 1 as illustrated in FIG. 6) may be identified through table HTML tags, or spatial patterns. Spatial patterns as in repeating X, Y coordinates with whitespace between content. This diverges from normal free text that has a more random, uniform distribution of spatial alignments (e.g., a paragraph and that there are no “hole” or “spaces” between content, unlike the table below.)

| | | |
|---|---|---|
| This | Is | An |
| Example | Where | Spacing |
| Is | Not | Random |

Using these spatial coordinates, the ATIEM 406 may employ a UNION-FIND (also known as a DISJOINT-SET) data structure. This data structure efficiently joins correlated sets of items together if just one pairing in to disjoint sets “aligns”.

For example, the ATIEM 406 may align columns by looking at the spatial overlap of the X coordinates (width). If there is significant Intersection over there Union (IOU) or complete overlap, the ATIEM 406 may UNION the two cells. On a row basis, the ATEIM 406 may plot a histogram of space (width) to the next text content and find an optimal threshold to differentiate normal text space from column separated spaces. The ATEIM 406 may UNION values under the threshold to form a row cell. The ATIEM 406 may sort by the Y coordinate, then by the X coordinates. The ATEIM 406 may also replicate the spatial alignment in a data frame, excel, csv from the cell grid created in this process.

In some embodiments, HTML tables (see, e.g., FIG. 6) may be easier as they may be already tagged by row and column. However, some HTML documents may only give X,Y coordinates and the above spatial algorithm may be used instead.

In some embodiments, radial context search implemented by the ATIEM 406 may refer to an algorithm searching the neighborhood of the table for signals such as: UNITS—in thousands, in millions, etc., —qualifiers to alter the reported text values to the true, correct numbers. i.e., 4->4,000 if in thousands; Hierarchy, Entity—entity recognition or identifying reporting entitles to link values to a certain company, fund, if not listed in the table.

In some embodiments, linking row fields, via the linking module 430 of the ATIEM 406, to values may be performed through the Y-coordinate overlap.

Linking columns, via the linking module 430 of the ATIEM 406, to values may require column identification via the following processes. For example, a first process may include: identifying number of row spans (how many lines to merge) based on where the first row field starts. For example, all lines belong to the column until the first cross-referenced row value is listed. (Relevant section in FIG. 6, all lines above it may be column headers). For example, if relevant section in FIG. 6 represents “Assets,” table extraction by the ATIEM 406 may execute the following steps, but the disclosure is not limited thereto: discovering relevant sections; identifying the tables in those sections; identifying a relevant key/row field (i.e., net assets, fees, etc.); spatially-aligning value; aligning column; and adjusting units to reflect the true value over reported value (i.e., in thousands).

In some embodiments the second process in linking columns may include: spatially-aware model to predict tokens as part of row, column, values, then post-hoc extract into triplets.

In some embodiments, extraction of data from tables in PDF documents, through a multi-modal fusion of natural language processing and computer vision. For example, Natural Language Processing (NLP) model may be implemented by the ATIEM 406. The NLP model may utilize artificial intelligence (AI) and machine learning to enable the ATIEM 406 to understand and communicate with human language.

In some embodiments, the ATIEM 406 may utilize Named Entity Recognition (NER) algorithm/model to identify fields, such as net assets. NER is an NLP method that seeks to locate and classify named entities mentioned in unstructured text into pre-defined categories such as person names, organizations, locations, medical codes, time expressions, quantities, monetary values, percentages, etc.

In some embodiments, the ATIEM 406 may utilize Part-Of-Speech to identify currency values, dates. And proper nouns for enemies or fund names.

In some embodiments, the ATIEM 406 may implement vision alignment with spatial coordinates.

The ATIEM 406 may be configured to perform automated validation, cross-referencing of related data extracted from different sections. For example, through entity matching, the ATEIM 406 may match values from a “Portfolio of Investments” and “Statements of Assets and Liabilities” to cross-reference values such as net assets.

In some embodiments, the ATIEM 406 may utilize built in named entity resolution to group managers, subsidiaries, and providers into a single parent entity. Named entity resolution is a subtask of information extraction that seeks to locate and classify named entities mentioned in unstructured text into pre-defined categories such as person names, organizations, locations, medical codes, time expressions, quantities, monetary values, percentages, etc.

In some embodiments, the ATIEM 406 may be configured to approximately match and disambiguate extracted funds with third party (i.e., Securities and Exchange Commission (SEC)) filing identifiers.

For example, given an optional list of candidates, such as those found in Electronic Data Gathering, Analysis, and Retrieval system (EDGAR) SEC filings, the ATEIM 406 may perform a matching algorithm to match (fuzzy partial) a column fund/entity with a reported entity to link more metadata to the triplet values.

For example, Nationwide Cybersecurity Review (NCSR) provides a SERIES-ID that allows the ATIEM 406 to link a fund to other documents. Linking a triplet value to this ID may allow the ATIEM 406 to merge information across documents and filings.

Referring back to FIGS. 4-6, the receiving module 414 may be configured to receive the variably sized document 502. The streaming module 416 may be configured to stream content of the variably sized document 502 line by line in a sliding window (see, e.g., FIG. 6) to identify breakpoints. The streaming may be independent to the number of tables in the document, or length of the document, and the breakpoints may identify start and end of a table (i.e., instance with singe table 506 as illustrated in FIG. 5 or Table 1 as illustrated in FIG. 6). The identifying module 418 may be configured to identify and extract a table (i.e., instance with a single table 506) within the document 502 based on the breakpoints. The implementing module 420 may be configured to implement spatially aware parsing algorithm for layout analysis, table constructions, and radial context search from the identified table (i.e., instance with singe table 506 as illustrated in FIG. 5 or Table 1 as illustrated in FIG. 6). The structuring module 422 may be configured to automatically structure the table in structured triplets of index, column, and value that dictates a row, a column, and an entry value, respectively.

In some embodiments, the implementing module 420 may be configured to implement an extract or partial fuzzy matching algorithm to find predefined keywords within the document 502 to be utilized as the breakpoints.

In some embodiments, the generating module 424 may be configured to generate spatial coordinates by implementing spatial patterns as in repeating X, Y coordinates with whitespace between content from the identified table (i.e., instance with singe table 506 as illustrated in FIG. 5 or Table 1 as illustrated in FIG. 6) thereby diverging from normal free text that has a more random, uniform distribution of spatial alignments. The generating module 424 may be further configured to generate a data structure from the spatial coordinates, wherein the data structure may store non overlapping or disjoint subset of elements.

In some embodiments, the aligning module 426 may be further configured to align columns of the identified table (i.e., instance with singe table 506 as illustrated in FIG. 5 or Table 1 as illustrated in FIG. 6) based on spatial overlap of the X coordinates.

In some embodiments, the plotting module 428 may be configured to plot a histogram of space, on a row basis, to a next text content; and the identifying module 418 may be configured to identify an optimal threshold to differentiate normal text space from column separated spaces.

In some embodiments, the linking module 430 may be configured to link row fields to values via Y coordinate overlap.

In some embodiments, in the radial context search, the searching module 432 may be configured to search all points within a vector space that reside within a specified maximum distance or minimum score threshold from a query point.

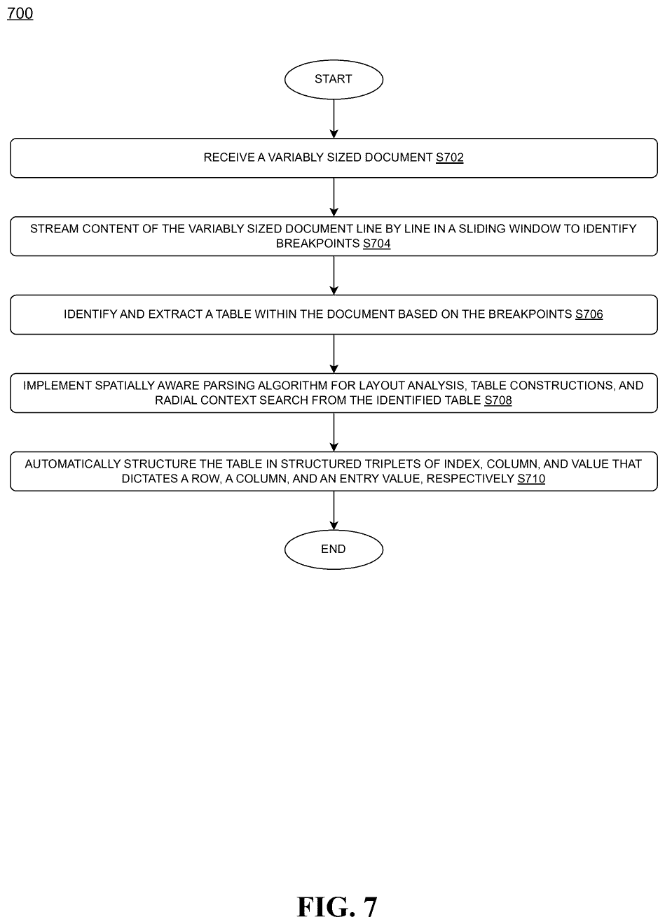

FIG. 7 illustrates a flow chart of a process 700 implemented by the platform, language, database, and cloud agnostic ATIEM 406 of FIG. 4 for implementing an algorithm and methodology to automatically identify and extract tables in documents and structure tables in structured triplets of index, column, value in accordance with an embodiment. It may be appreciated that the illustrated process 700 and associated steps may be performed in a different order, with illustrated steps omitted, with additional steps added, or with a combination of reordered, combined, omitted, or additional steps.

As illustrated in FIG. 7, at step S702, the process 700 may include receiving a variably sized document.

At step S704, the process 700 may include streaming content of the variably sized document line by line in a sliding window to identify breakpoints. The streaming may be independent to the number of tables in the document, or length of the document, and wherein the breakpoints identify start and end of a table;

At step S706, the process 700 may include identifying and extracting a table within the document based on the breakpoints.

At step S708, the process 700 may include automatically structuring the table in structured triplets of index, column, and value that dictates a row, a column, and an entry value, respectively.

In some embodiments, in the process 700, the variably sized document may include one or more of the following: PDFs, Word, HTML, and XML, but the disclosure is not limited thereto.

In some embodiments, the process 700 may further include: implementing an extract or partial fuzzy matching algorithm to find predefined keywords within the document to be utilized as the breakpoints.

In some embodiments, the process 700 may further include: generating spatial coordinates by implementing spatial patterns as in repeating X, Y coordinates with whitespace between content from the identified table thereby diverging from normal free text that has a more random, uniform distribution of spatial alignments; and generating a data structure from the spatial coordinates, wherein the data structure stores non overlapping or disjoint subset of elements.

In some embodiments, the process 700 may further include: aligning columns of the identified table based on spatial overlap of the X coordinates.

In some embodiments, the process 700 may further include: plotting a histogram of space, on a row basis, to a next text content; and identifying an optimal threshold to differentiate normal text space from column separated spaces.

In some embodiments, the process 700 may further include: linking row fields to values via Y coordinate overlap.

In some embodiments, in the radial context search, the process 700 may further include: searching all points within a vector space that reside within a specified maximum distance or minimum score threshold from a query point.

In some embodiments, the ATIED 402 may include a memory (e.g., a memory 106 as illustrated in FIG. 1) which may be a non-transitory computer readable medium that may be configured to store instructions for implementing a platform, language, database, and cloud agnostic ATIEM 406 for implementing an algorithm and methodology to automatically identify and extract tables in documents and structure tables in structured triplets of index, column, value as disclosed herein. The ATIED 402 may also include a medium reader (e.g., a medium reader 112 as illustrated in FIG. 1) which may be configured to read any one or more sets of instructions, e.g., software, from any of the memories described herein. The instructions, when executed by a processor embedded within the ATIEM 406 or within the ATIED 402, may be used to perform one or more of the methods and processes as described herein. In a particular embodiment, the instructions may reside completely, or at least partially, within the memory 106, the medium reader 112, and/or the processor 104 (see FIG. 1) during execution by the ATIED 402.

In some embodiments, the instructions, when executed, may cause a processor embedded within the ATIEM 406 or the ATIED 402 to perform the following: receiving a variably sized document; streaming content of the variably sized document line by line in a sliding window to identify breakpoints, wherein the streaming is independent to the number of tables in the document, or length of the document, and wherein the breakpoints identify start and end of a table; identifying and extracting a table within the document based on the breakpoints; implementing spatially aware parsing algorithm for layout analysis, table constructions, and radial context search from the identified table; and automatically structuring the table in structured triplets of index, column, and value that dictates a row, a column, and an entry value, respectively, but the disclosure is not limited thereto. In some embodiments, the processor may be the same or similar to the processor 104 as illustrated in FIG. 1 or the processor embedded within the ATIED 202, ATIED 302, ATIED 402, and ATIEM 406 which is the same or similar to the processor 104.

In some embodiments, the instructions, when executed, may cause the processor 104 to further perform the following: implementing an extract or partial fuzzy matching algorithm to find predefined keywords within the document to be utilized as the breakpoints.

In some embodiments, the instructions, when executed, may cause the processor 104 to further perform the following: generating spatial coordinates by implementing spatial patterns as in repeating X, Y coordinates with whitespace between content from the identified table thereby diverging from normal free text that has a more random, uniform distribution of spatial alignments; and generating a data structure from the spatial coordinates, wherein the data structure stores non overlapping or disjoint subset of elements.

In some embodiments, the instructions, when executed, may cause the processor 104 to further perform the following: aligning columns of the identified table based on spatial overlap of the X coordinates.

In some embodiments, the instructions, when executed, may cause the processor 104 to further perform the following: plotting a histogram of space, on a row basis, to a next text content; and identifying an optimal threshold to differentiate normal text space from column separated spaces.

In some embodiments, the instructions, when executed, may cause the processor 104 to further perform the following: linking row fields to values via Y coordinate overlap.

In some embodiments, in the radial context search, the instructions, when executed, may cause the processor 104 to further perform the following: searching all points within a vector space that reside within a specified maximum distance or minimum score threshold from a query point.

In some embodiments as disclosed above in FIGS. 1-7, technical improvements effected by the instant disclosure may include a platform for implementing a platform, language, database, and cloud agnostic automatic table identification and extraction module configured for implementing an algorithm and methodology to automatically identify and extract tables in documents (i.e., financial forms) and structure tables in structured triplets of index, column, value that dictate the row (index), column (column), and entry value (value), but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware embodiments, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware embodiments, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatic table identification and extraction in a document by utilizing one or more processors along with allocated memory, the method comprising:
receiving a variably sized document;
streaming content of the variably sized document line by line in a sliding window to identify breakpoints, wherein the streaming is independent to the number of tables in the document, or length of the document, and wherein the breakpoints identify start and end of a table;
identifying and extracting a table within the document based on the breakpoints;
implementing spatially aware parsing algorithm for layout analysis, table constructions, and radial context search from the identified table; and
automatically structuring the table in structured triplets of index, column, and value that dictates a row, a column, and an entry value, respectively.

2. The method according to claim 1, wherein the variably sized document includes one or more of the following: Portable Document Formats (PDFs), Word, Hyper Text Markup Language (HTML), and Extensible Markup Language (XML).

3. The method according to claim 1, further comprising:
implementing an extract or partial fuzzy matching algorithm to find predefined keywords within the document to be utilized as the breakpoints.

4. The method according to claim 1, further comprising:
generating spatial coordinates by implementing spatial patterns as in repeating X, Y coordinates with whitespace between content from the identified table thereby diverging from normal free text that has a more random, uniform distribution of spatial alignments; and
generating a data structure from the spatial coordinates, wherein the data structure stores non overlapping or disjoint subset of elements.

5. The method according to claim 4, further comprising:
aligning columns of the identified table based on spatial overlap of the X coordinates.

6. The method according to claim 5, further comprising:
plotting a histogram of space, on a row basis, to a next text content; and
identifying an optimal threshold to differentiate normal text space from column separated spaces.

7. The method according to claim 4, further comprising:
linking row fields to values via Y coordinate overlap.

8. The method according to claim 1, wherein the radial context search further comprising:
searching all points within a vector space that reside within a specified maximum distance or minimum score threshold from a query point.

9. A system for automatic table identification and extraction in a document, the system comprising:
a processor; and
a memory operatively connected to the processor via a communication interface, the memory storing computer readable instructions, when executed, causes the processor to:
receive a variably sized document;
stream content of the variably sized document line by line in a sliding window to identify breakpoints, wherein the streaming is independent to the number of tables in the document, or length of the document, and wherein the breakpoints identify start and end of a table;
identify and extract a table within the document based on the breakpoints;
implement spatially aware parsing algorithm for layout analysis, table constructions, and radial context search from the identified table; and
automatically structure the table in structured triplets of index, column, and value that dictates a row, a column, and an entry value, respectively.

10. The system according to claim 9, wherein the variably sized document includes one or more of the following: Portable Document Formats (PDFs), Word, Hyper Text Markup Language (HTML), and Extensible Markup Language (XML).

11. The system according to claim 9, wherein the processor is further configured to:
implement an extract or partial fuzzy matching algorithm to find predefined keywords within the document to be utilized as the breakpoints.

12. The system according to claim 9, wherein the processor is further configured to:
generate spatial coordinates by implementing spatial patterns as in repeating X, Y coordinates with whitespace between content from the identified table thereby diverging from normal free text that has a more random, uniform distribution of spatial alignments; and
generate a data structure from the spatial coordinates, wherein the data structure stores non overlapping or disjoint subset of elements.

13. The system according to claim 12, wherein the processor is further configured to:
align columns of the identified table based on spatial overlap of the X coordinates.

14. The system according to claim 13, wherein the processor is further configured to:
plot a histogram of space, on a row basis, to a next text content; and
identify an optimal threshold to differentiate normal text space from column separated spaces.

15. The system according to claim 12, wherein the processor is further configured to:
link row fields to values via Y coordinate overlap.

16. The system according to claim 9, in the radial context search, the processor is further configured to:
search all points within a vector space that reside within a specified maximum distance or minimum score threshold from a query point.

17. A non-transitory computer readable medium configured to store instructions for automatic table identification and extraction in a document, the instructions, when executed, cause a processor to perform the following:
receiving a variably sized document;
streaming content of the variably sized document line by line in a sliding window to identify breakpoints, wherein the streaming is independent to the number of tables in the document, or length of the document, and wherein the breakpoints identify start and end of a table;
identifying and extracting a table within the document based on the breakpoints;
implementing spatially aware parsing algorithm for layout analysis, table constructions, and radial context search from the identified table; and
automatically structuring the table in structured triplets of index, column, and value that dictates a row, a column, and an entry value, respectively.

18. The non-transitory computer readable medium according to claim 17, wherein the variably sized document includes one or more of the following: Portable Document Formats (PDFs), Word, Hyper Text Markup Language (HTML), and Extensible Markup Language (XML).

19. The non-transitory computer readable medium according to claim 17, the instructions, when executed, cause the processor to further perform the following:
implementing an extract or partial fuzzy matching algorithm to find predefined keywords within the document to be utilized as the breakpoints.

20. The non-transitory computer readable medium according to claim 17, the instructions, when executed, cause the processor to further perform the following:
generating spatial coordinates by implementing spatial patterns as in repeating X, Y coordinates with whitespace between content from the identified table thereby diverging from normal free text that has a more random, uniform distribution of spatial alignments; and
generating a data structure from the spatial coordinates, wherein the data structure stores non overlapping or disjoint subset of elements.
